(19) United States
(12) Patent Application Publication
(10) Pub. No.: US 2026/0270982 A1
(43) Pub. Date: Sep. 10, 2026

(54) DISCONTINUOUS COMMUNICATIONS

(71) Applicant: QUALCOMM Incorporated, San Diego, CA (US)

(72) Inventors: Gabi SARKIS, San Diego, CA (US); Diana MAAMARI, San Diego, CA (US); Le LIU, San Jose, CA (US)

(21) Appl. No.: 19/075,681

(22) Filed: Mar. 10, 2025

(51) Int. Cl. H04W 72/1263; H04L 27/26; H04W 74/0833

(52) U.S. Cl. CPC H04W 72/1263; H04L 27/2607; H04W 74/0833

(57) ABSTRACT

Methods, systems, and devices for wireless communications are described. A network entity may transmit control signaling indicating that the network entity supports threshold time gaps between wireless communications scheduled at a UE. The UE may, in some examples, transmit, in response to receiving the control signaling, a capability information message indicating a gap between communications at the UE, wherein performing the wireless communications is in accordance with the gap indicated in the capability information message. The UE may perform the wireless communications with the network entity in accordance with at least the threshold time gaps between the wireless communications.

### FIELD OF TECHNOLOGY

The following relates to wireless communications, including discontinuous communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include receiving control signaling indicating that a network entity supports threshold time gaps between wireless communications scheduled at the UE and performing the wireless communications with the network entity in accordance with at least the threshold time gaps between the wireless communications.

A UE for wireless communication is described. The UE may include one or more processors, and instructions stored in one or more memories. The instructions may be executable by the one or more processors, individually or collectively, to cause the UE to receive control signaling indicating that a network entity supports threshold time gaps between wireless communications scheduled at the UE and perform the wireless communications with the network entity in accordance with at least the threshold time gaps between the wireless communications.

Another UE for wireless communication is described. The UE may include means for receiving control signaling indicating that a network entity supports threshold time gaps between wireless communications scheduled at the UE and means for performing the wireless communications with the network entity in accordance with at least the threshold time gaps between the wireless communications.

A non-transitory computer-readable medium storing code for wireless communication is described. The code may include instructions executable by one or more processors to receive control signaling indicating that a network entity supports threshold time gaps between wireless communications scheduled at the UE and perform the wireless communications with the network entity in accordance with at least the threshold time gaps between the wireless communications.

In some examples of the method, UEs, and non-transitory computer-readable medium described herein, the control signaling includes system information block (SIB) or a master information block (MIB).

In some examples of the method, UEs, and non-transitory computer-readable medium described herein, the control signaling includes a synchronization signal block (SSB).

In some examples of the method, UEs, and non-transitory computer-readable medium described herein, an SSB sequence may be based on an input that indicates that the network entity supports the threshold time gaps.

In some examples of the method, UEs, and non-transitory computer-readable medium described herein, a demodulation reference signal (DMRS) sequence may be based on an input that indicates that the network entity supports the threshold time gaps.

In some examples of the method, UEs, and non-transitory computer-readable medium described herein, a presence or an absence of at least one cyclic redundancy check (CRC) mask indicates that the network entity supports the threshold time gaps.

Some examples of the method, UEs, and non-transitory computer-readable medium described herein may further include operations, features, means, or instructions for transmitting, in response to receiving the control signaling, a capability information message indicating a gap between communications at the UE, where performing the wireless communications may be in accordance with the gap indicated in the capability information message.

In some examples of the method, UEs, and non-transitory computer-readable medium described herein, the capability information message includes an indication that the gap may be between consecutive receptions, consecutive transmissions, or both at the UE.

In some examples of the method, UEs, and non-transitory computer-readable medium described herein, the capability information message includes at least one of an indication of a duration of the gap and a duration of communications before the gap.

Some examples of the method, UEs, and non-transitory computer-readable medium described herein may further include operations, features, means, or instructions for transmitting a first random access message as part of an initial access procedure based on receiving the control signaling, where the first random access message includes an indication that the gap may be between consecutive receptions, consecutive transmissions, or both at the UE and receiving a second random access message in response to the first random access message to connect to the network entity, where receiving the second random access message may be in accordance with the indication, and where transmitting the capability information message may be based on connecting to the network entity.

In some examples of the method, UEs, and non-transitory computer-readable medium described herein, the indication includes at least one of a random access channel (RACH) preamble, a RACH occasion, a random access message payload, and an early UE capability indication message.

Some examples of the method, UEs, and non-transitory computer-readable medium described herein may further include operations, features, means, or instructions for monitoring for the second random access message via one or more random access occasions that occur at least an amount of time that satisfies the gap after transmitting the first random access message, where the one or more random access occasions may be indicated via a SIB, a MIB, an additional random access message, a periodicity for random access occasions, or any combination thereof.

In some examples of the method, UEs, and non-transitory computer-readable medium described herein, the capability information message includes at least one of a duration of the gap and a quantity of consecutive communications before the gap.

Some examples of the method, UEs, and non-transitory computer-readable medium described herein may further include operations, features, means, or instructions for receiving a control message allocating resources for a first communication and a second communication, where the second communication may be offset from the first communication by at least the gap indicated in the capability information message, and where performing the wireless communications may be based on receiving the control message.

A method for wireless communication by a network entity is described. The method may include transmitting control signaling indicating that the network entity supports threshold time gaps between wireless communications scheduled at a UE and performing the wireless communications with the UE in accordance with at least the threshold time gaps between the wireless communications.

A network entity for wireless communication is described. The network entity may include one or more processors, and instructions stored in one or more memories. The instructions may be executable by the one or more processors, individually or collectively, to cause the network entity to transmit control signaling indicating that the network entity supports threshold time gaps between wireless communications scheduled at a UE and perform the wireless communications with the UE in accordance with at least the threshold time gaps between the wireless communications.

Another network entity for wireless communication is described. The network entity may include means for transmitting control signaling indicating that the network entity supports threshold time gaps between wireless communications scheduled at a UE and means for performing the wireless communications with the UE in accordance with at least the threshold time gaps between the wireless communications.

A non-transitory computer-readable medium storing code for wireless communication is described. The code may include instructions executable by one or more processors to transmit control signaling indicating that the network entity supports threshold time gaps between wireless communications scheduled at a UE and perform the wireless communications with the UE in accordance with at least the threshold time gaps between the wireless communications.

In some examples of the method, network entities, and non-transitory computer-readable medium described herein, the control signaling includes SIB or a MIB.

In some examples of the method, network entities, and non-transitory computer-readable medium described herein, the control signaling includes an SSB.

In some examples of the method, network entities, and non-transitory computer-readable medium described herein, an SSB sequence may be based on an input that indicates that the network entity supports the threshold time gaps.

In some examples of the method, network entities, and non-transitory computer-readable medium described herein, a DMRS sequence may be based on an input that indicates that the network entity supports the threshold time gaps.

In some examples of the method, network entities, and non-transitory computer-readable medium described herein, a presence or an absence of at least one CRC mask indicates that the network entity supports the threshold time gaps.

Some examples of the method, network entities, and non-transitory computer-readable medium described herein may further include operations, features, means, or instructions for receiving, in response to transmitting the control signaling, a capability information message indicating a gap between communications at the UE, where performing the wireless communications may be in accordance with the gap indicated in the capability information message.

In some examples of the method, network entities, and non-transitory computer-readable medium described herein, the capability information message includes an indication that the gap may be between consecutive receptions, consecutive transmissions, or both at the UE.

In some examples of the method, network entities, and non-transitory computer-readable medium described herein, the capability information message includes at least one of an indication of a duration of the gap and a duration of communications before the gap.

Some examples of the method, network entities, and non-transitory computer-readable medium described herein may further include operations, features, means, or instructions for receiving a first random access message as part of an initial access procedure based on transmitting the control signaling, where the first random access message includes an indication that the gap may be between consecutive receptions, consecutive transmissions, or both at the UE and transmitting a second random access message in response to the first random access message indicating to the UE to connect to the network entity, where transmitting the second random access message may be in accordance with the indication, and where receiving the capability information message may be based on the UE connecting to the network entity.

In some examples of the method, network entities, and non-transitory computer-readable medium described herein, the indication includes at least one of a RACH preamble, a RACH occasion, a random access message payload, and an early UE capability indication message.

In some examples of the method, network entities, and non-transitory computer-readable medium described herein, the capability information message includes at least one of a duration of the gap and a quantity of consecutive communications before the gap.

Some examples of the method, network entities, and non-transitory computer-readable medium described herein may further include operations, features, means, or instructions for transmitting a control message allocating resources for a first communication and a second communication, where the second communication may be offset from the first communication by at least the gap indicated in the capability information message, and where performing the wireless communications may be based on transmitting the control message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports discontinuous communications in accordance with one or more aspects of the present disclosure.

FIG. 2 shows an example of a wireless communications system that supports discontinuous communications in accordance with one or more aspects of the present disclosure.

FIG. 3 shows an example of a process flow that supports discontinuous communications in accordance with one or more aspects of the present disclosure.

FIGS. 4 and 5 show block diagrams of devices that support discontinuous communications in accordance with one or more aspects of the present disclosure.

FIG. 6 shows a block diagram of a communications manager that supports discontinuous communications in accordance with one or more aspects of the present disclosure.

FIG. 7 shows a diagram of a system including a device that supports discontinuous communications in accordance with one or more aspects of the present disclosure.

FIGS. 8 and 9 show block diagrams of devices that support discontinuous communications in accordance with one or more aspects of the present disclosure.

FIG. 10 shows a block diagram of a communications manager that supports discontinuous communications in accordance with one or more aspects of the present disclosure.

FIG. 11 shows a diagram of a system including a device that supports discontinuous communications in accordance with one or more aspects of the present disclosure.

FIGS. 12 through 15 show flowcharts illustrating methods that support discontinuous communications in accordance with one or more aspects of the present disclosure.

### DETAILED DESCRIPTION

Some wireless communications systems may include energy-saving user equipments (UEs) that implement gaps between uplink transmissions, downlink receptions, or both. For example, a UE may process downlink receptions at a reduced speed to save energy, or may rely on an extended period of time to buffer uplink transmissions. Such a UE may accordingly be designed to assume a threshold gap between communications to allow time for processing and prevent overflowing of a UE buffer. Such energy-saving UEs may operate with a full bandwidth but may assume (e.g., rely on) gaps between communications to reduce baseband implementation complexity and energy consumption. However, such energy-saving UEs may coexist with other UEs that do not implement gaps between communications, and the network utilizing separate resources for the energy-saving UEs and other UEs may be inefficient in terms of energy expenditure and resource allocation. Thus, techniques allowing wireless communications systems to support energy-saving UEs that assume gaps between communications in a manner that is resource-efficient and allows the energy-saving UEs to coexist with other UEs (e.g., that do not assume gaps) may be beneficial.

Accordingly, techniques described herein may allow a wireless communications system to support both energy-saving UEs that assume gaps between communications and UEs that do not implement gaps between communications. A network entity may indicate whether a cell supports UEs that assume gaps between communications (e.g., via synchronization signal block (SSB) or system information block (SIB)). A UE that assumes gaps between communications may identify a cell in which such a UE is supported based on the indication. In some cases, the UE may transmit a random access channel (RACH) message to the network indicating one or more gap requirements (e.g., gaps between consecutive receptions from the network, gaps between consecutive transmissions to the network, or both) at the UE as part of an initial access procedure. In some examples, the network may respond to the RACH message or otherwise participate in a random access procedure in a manner consistent with the one or more gap requirements at the UE. In some examples (e.g., after the initial access procedure or in place of the random access procedure), the UE may transmit capability signaling including information about a gap between communications at the UE (e.g., a quantity of consecutive communications supported before the gap, a size of the gap, or both). The exchange of a network indication of support for energy-saving UEs that assume gaps between communications and capability signaling indicating a gap at such energy-saving UEs may reduce overhead, resource costs, and energy expenditure associated with supporting both the energy-saving UEs and other UEs in a same network.

Aspects of the disclosure are initially described in the context of wireless communications systems. Aspects of the disclosure are further illustrated by and described with reference to wireless communications systems and process flows. Aspects of the disclosure are further illustrated by and described with reference to apparatus diagrams, system diagrams, and flowcharts that relate to discontinuous communications.

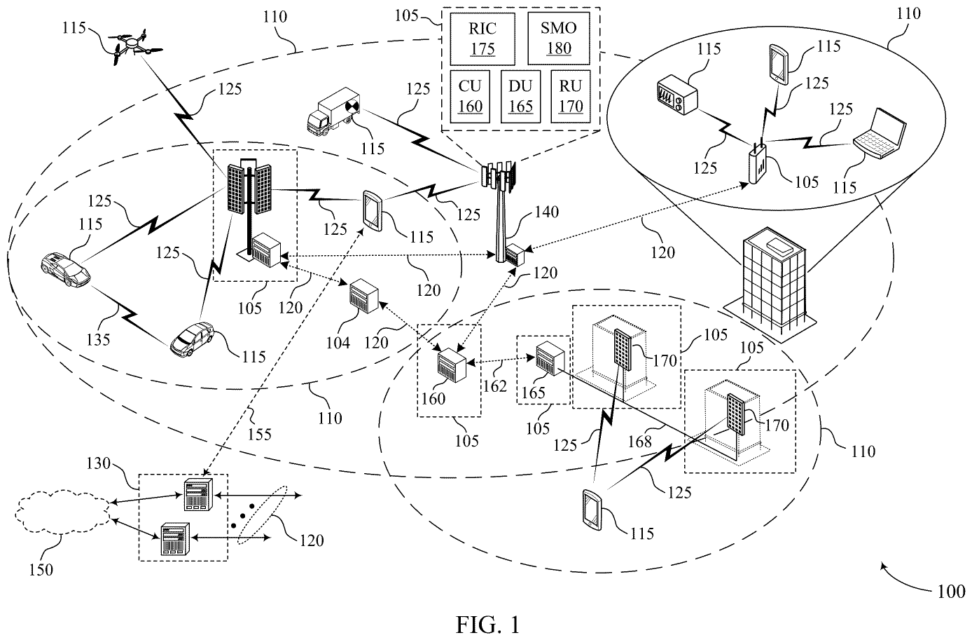

FIG. 1 shows an example of a wireless communications system 100 that supports discontinuous communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support discontinuous communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

Some UEs 115 may be ambient IoT devices that lack a power source (e.g., a battery) and harvest energy from the environment. Such ambient IoT devices may implement time gaps between communications (e.g., transmissions, receptions, or both) to allow time for energy harvesting. The ambient IoT devices may implement initial access procedures specific to such ambient IoT devices (e.g., different from one or more general initial access procedures for other UEs 115). In some cases, the ambient IoT devices may be unable to coexist in the wireless communications system 100 with other UEs 115 (which may not be ambient IoT devices) in a same frequency and a same time.

Some UEs 115 may be reduced capability (RedCap) or enhanced RedCap (eRedCap) devices. Such RedCap and eRedCap devices may operate with a reduced maximum bandwidth, a reduced maximum throughput, a reduced quantity of antennas, or any combination thereof. The RedCap and eRedCap devices may receive on a contiguous slot (e.g., without time gaps) so long as receptions are in accordance with the reduced capabilities of the devices.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support discontinuous communications between network entities 105 and UEs 115 that assume gaps between communications for energy saving. The wireless communications system 100 may support both UEs 115 that assume gaps between communications and UEs 115 that do not implement gaps between communications in accordance with the techniques described herein. A network entity 105 may transmit control signaling indicating that the network entity 105 supports UEs 115 that assume threshold time gaps between wireless communications. A UE 115 may receive the control signaling and, in response, transmit a capability information message indicating a gap between communications at the UE 115. For example, the capability information message may indicate a type of gap assumed by the UE 115 (e.g., a gap between transmissions, receptions, or both), a duration of the gap, a duration of communications before the gap, or any combination thereof. The UE 115 may perform wireless communications with the network entity 105 in accordance with the gap indicated in the capability information message.

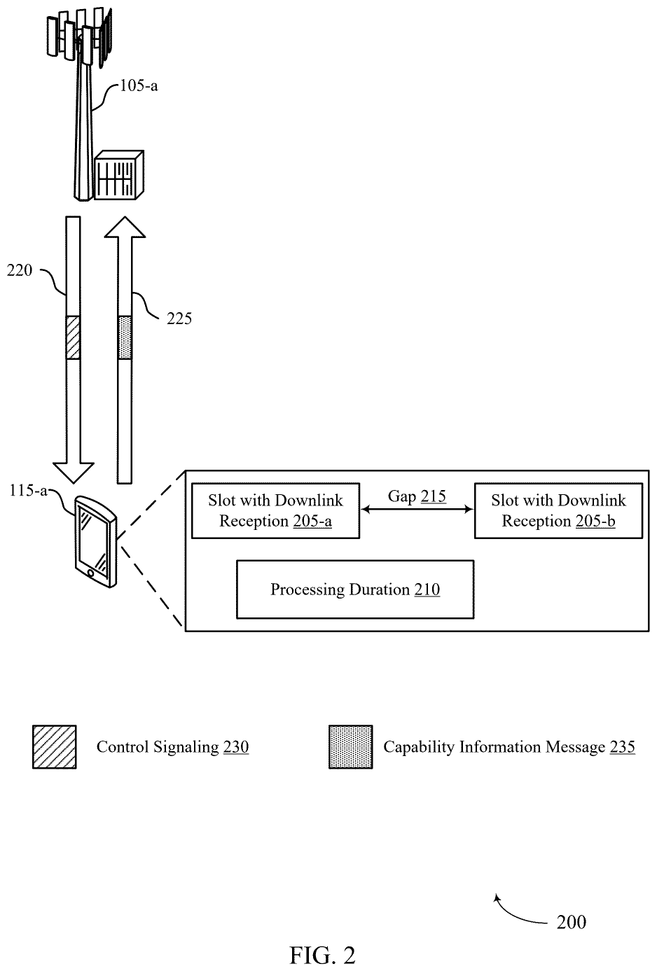

FIG. 2 shows an example of a wireless communications system 200 that supports discontinuous communications in accordance with one or more aspects of the present disclosure. In some examples, the wireless communications system 200 may implement, or be implemented by, aspects of the wireless communications system 100. For example, the wireless communications system 200 may include a network entity 105-a and a UE 115-a, which may be examples of network entities 105, UEs 115, and other devices as described with reference to FIG. 1.

In some examples, the wireless communications system 200 may support energy-saving UEs that assume gaps between communications (e.g., receptions, transmissions, or both). In some cases, such energy-saving UEs may be different than ambient IoT devices, RedCap devices, and eRedCap devices. For the energy-saving UEs, radio frequency and baseband power states may be decoupled such that the energy-saving UEs may receive transmissions at a regular rate (e.g., at a regular speed over the air) but may process the transmissions at a reduced speed to save energy (e.g., may use more time to process and decode transmissions). Accordingly, the energy-saving UEs may be designed to assume time gaps between downlink transmissions and a relaxed feedback mechanism in order to reduce baseband implementation complexity and allow time for processing of the transmissions at the reduced speed.

For example, the UE 115-a may be an example of an energy-saving UE that assumes (e.g., relies on) gaps between communications, and the UE 115-a may receive downlink communications (e.g., physical downlink shared channel (PDSCH), channel state information (CSI) reference signal (RS)) in one or more slots 205. The UE 115-a may receive (e.g., over-the-air at an unreduced speed) a downlink communication in a slot 205-a, and the UE 115-a may process (e.g., and decode) the downlink communication at a reduced speed (e.g., for energy savings) for a processing duration 210. The processing duration 210 may continue for a duration after the slot 205-a, and the UE 115-a may accordingly implement (e.g., expect) equal to or greater than a gap 215 between the slot 205-a and a slot 205-b to allow the UE 115-a to finish processing the downlink communication received in the slot 205-a before receiving subsequent downlink communications in the slot 205-b. That is, the UE 115-a may implement the gap 215 to prevent overflowing of a UE buffer (e.g., the UE buffer may be unable to simultaneously store both the downlink communication received in the slot 205-a and the subsequent downlink communications in the slot 205-b). The UE 115-a may be designed to assume a gap 215 of a threshold (e.g., minimum) value between transmissions from the network entity 105-a.

The implementation of the UE 115-a and other energy-saving UEs that assume gaps between communications in the wireless communications system 200 may reduce energy consumption at both the energy-saving UEs and the network. For example, the energy-saving UEs reduce device energy consumption by processing communications at a reduced speed. The implementation of the energy-saving UEs that assume gaps may reduce energy consumption at the network entity 105-a compared to eRedCap devices that do not assume gaps as the energy-saving UEs may operate at a full bandwidth, allowing the network entity 105-a to finish transmissions to the UE 115-a at a faster rate than to an eRedCap device or another narrowband device. Similarly, while ambient IoT devices may implement discontinuous reception, such ambient IoT devices may limit network efficiency and be unable to coexist with other types of devices. The energy-saving UEs that assume gaps between communications may lack these limitations and thereby improve network efficiency and energy savings.

Thus, a framework for supporting such energy-saving UEs that assume gaps between communications may be beneficial. For example, if a network entity 105-a is unaware of which UEs 115 rely on gaps, and which UEs do not, then the network entity 105-a may either overschedule UEs that do not support communications without gaps (e.g., resulting in failed transmissions, retransmissions, system congestion, and increased system latency), or may under schedule UEs that are capable of communications without gaps (e.g., resulting in inefficient use of system resources, decreased throughput, increased system latency, and decreased user experience). Similarly, if energy saving UEs that rely on gaps are unable to determine which cells support such UE types, then the energy saving UEs may be unable to effectively communicate at all. Additionally, or alternatively, in some examples, without a mechanism to perform a random access procedure that satisfies the gaps relied on by the energy saving UEs, such energy saving UEs may be unable to connect to a cell (e.g., even if such a cell does support energy saving UEs).

Accordingly, techniques described herein allow wireless communications systems to support energy-saving UEs that assume gaps between communications in a manner that is resource-efficient and allows the energy-saving UEs to coexist with other UEs that may not implement gaps between communications. The UE 115-a may communicate with a network entity 105-a via a downlink connection 220 and an uplink connection 225, and the UE 115-a and the network entity 105-a may use these connections to communicate capability information about the UE 115-a that assumes gaps between communications and information about network support for the energy-saving UEs that assume gaps between communications.

In some examples of the wireless communications system 200, the network entity 105-a may transmit, via the downlink connection 220, control signaling 230 indicating whether the network entity 105-a supports UEs that assume gaps between communications. For example, the network entity 105-a may transmit control signaling 230 indicating that the network entity 105-a supports a threshold time gap between wireless communications at the UE 115-a. In some cases, the network entity 105-a may transmit the control signaling 230 via SIB or MIB. Additionally, or alternatively, the network entity 105-a may transmit the control signaling 230 via SSB.

In cases in which the network entity 105-a transmits the control signaling 230 via SSB, the network entity 105-a may include an indication of network support for UEs that assume gaps between communications in general SSB (e.g., for both UEs that assume gaps and other UEs that do not implement gaps). In some examples, the network entity 105-a may include an explicit bit in master information block (MIB) to indicate whether the network entity 105-a supports UEs that assume gaps between communications.

Additionally, or alternatively, the network entity 105-a may transmit SSBs specific to UEs that assume gaps between communications (e.g., SSB separate than general SSB for UEs that do not implement gaps). In some cases, one or more synchronization sequences (e.g., primary synchronization sequence (PSS), secondary synchronization sequence (SSS)) may indicate whether the network entity 105-a supports UEs that assume gaps between communications. For instance, the network entity 105-a may use an additional input (e.g., 1 bit) in a sequence generator or seed for the synchronization sequence to adjust the sequence based on whether the network entity 105-a supports UEs that assume gaps between communications. In such examples, the generated sequence (e.g., the PSS or SSS) may indicate whether the cell supports energy saving UEs that assume gaps between communications.

In some examples, a demodulation reference signal (DMRS) sequence may indicate whether the network entity 105-a supports UEs that assume gaps between communications. The network entity 105-a may use an additional input (e.g., 1 bit) in a sequence generator or seed for the DMRS sequence to adjust the DMRS sequence based on whether the network entity 105-a supports UEs that assume gaps between communications.

In some implementations, the network entity 105-a may implement cyclic redundancy check (CRC) masking (e.g., CRC scrambling) to differentiate SSBs specific to UEs that assume gaps between communications from other SSBs. For example, the use of a CRC mask on SSB may indicate that the network entity 105-a supports UEs that assume gaps between communications while unmasked SSBs may indicate that the network entity 105-a does not support UEs that assume gaps between communications, or the use of a CRC mask on SSB may indicate that the network entity 105-a does not support UEs that assume gaps between communications while unmasked SSB may indicate that the network entity 105-a does support UEs that assume gaps between communications. In such examples, the masked SSB may be transparent to one type of UE (e.g., either UEs that assume gaps between communications or UEs that do not implement gaps). In some cases, the network entity 105-a may use separate CRC masks to distinguish cells that support UEs that assume gaps between communications from cells in which UEs that assume gaps between communications are unsupported. That is, one CRC mask may indicate that UEs that assume gaps between communications are supported while a separate CRC mask may indicate that such UEs are unsupported.

In some aspects, the control signaling 230 may introduce greater than two levels of differentiation (e.g., UEs that assume gaps are supported or unsupported) to indicate network support for different types of gaps (e.g., gaps between consecutive receptions from the network, gaps between consecutive transmissions to the network, or both). That is, the control signaling 230 may include an indication that UEs that assume gaps are unsupported by the network entity 105-a or an indication of support for a particular type of gap or duration of gap, among other examples. For example, the network entity 105-a may use a first CRC mask to indicate that UEs that assume gaps between consecutive receptions are supported, a second CRC mask to indicate that UEs that assume gaps between consecutive transmissions are supported, and a lack of a CRC mask to indicate that UEs that assume gaps are unsupported. Similarly, different CRC masks, or seeds for PSSs or SSSs, DMRS sequences, or the like may indicate support of different types of gaps, or durations of supported gaps, or the like.

Based on receiving the control signaling 230 indicating that the network entity 105-a supports UEs that assume gaps between communications, the UE 115-a may, in some implementations, transmit a capability information message 235 indicating a gap to the network entity 105-a. The capability information message 235 may indicate a type of gap assumed by the UE 115-a. For example, the capability information message 235 may indicate gaps between consecutive receptions from the network, consecutive transmissions to the network, or both. The capability information message 235 may also indicate a size of a gap assumed by the UE 115-a, a quantity of consecutive communications (e.g., transmissions, receptions, or both) before the gap, or both. The size of the gap, the quantity of consecutive communications, or both may be expressed as a quantity of slots (e.g., or a unit of TTI), as a quantity of OFDM symbols (e.g., or another unit that is less than a slot), or as a unit of time (e.g., a quantity of milliseconds), among other examples. In some cases, the size of the gap may be dependent on, or associated with, the quantity of consecutive communications before the gap. For example, the UE 115-a may assume a gap of 10 OFDM symbols following 4 OFDM symbols of communications, and the UE 115-a may assume a shorter gap for a shorter duration of communications.

The capability information message 235 may include an indication of a gap, or a type of gap (e.g., gaps between consecutive receptions, consecutive transmission, or a combination thereof). The capability information message 235 may also indicate a communication information (e.g., regarding the nonconsecutive transmissions), having a granularity of slot (e.g., or other time units, such as symbols), or time (e.g., milliseconds). In some examples, the capability information may indicate an amount of communication that the UE 115-a is capable of receiving or transmissions before or after the gap. For example, the size of the gap 215 may be dependent on or related to an amount of pending uplink traffic or scheduled downlink traffic (e.g., and the granularity of the communications, the gap, or both, may be defined in slots, symbols, milliseconds, or the like). In some examples, the capability information message 235 may include an indication of a quantity of consecutive communications (e.g., transmissions, receptions, or both) before which the gap 215 is relied upon.

The exchange of the control signaling 230 and the capability information message 235 between the UE 115-a and the network entity 105-a, and similar exchanges between other UEs that assume gaps between communications and the network entity 105-a or other network entities, may allow the wireless communications system 200 to support UEs that assume gaps between communications alongside other UEs that do not assume gaps between communications in a resource-efficient manner. The integration of the UEs that assume gaps between communications into the wireless communications system 200 in accordance with the techniques herein may reduce resource costs and device energy consumption associated with the UEs that assume gaps while refraining from introducing significant overhead or resource costs at the network to support the UEs that assume gaps.

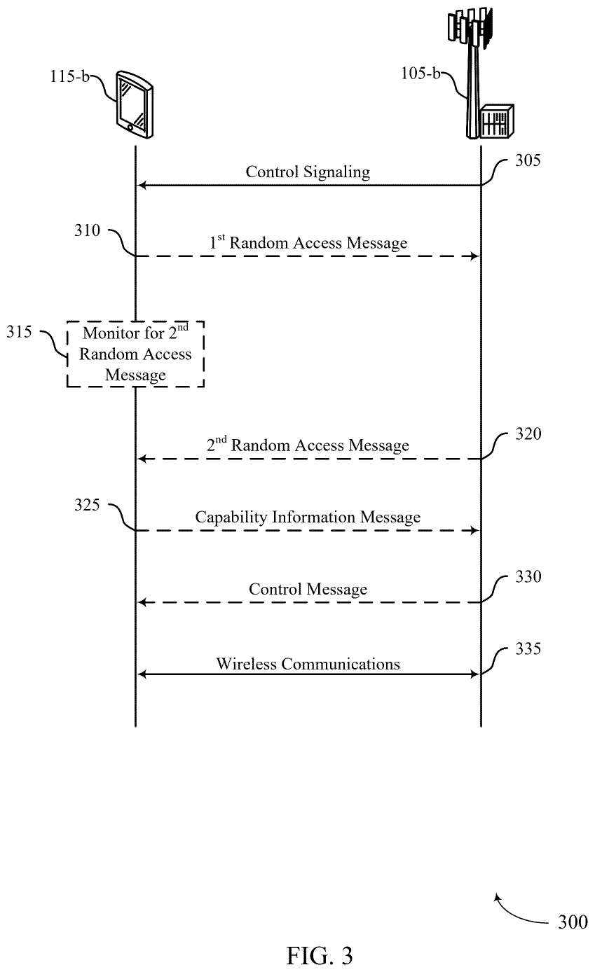

FIG. 3 shows an example of a process flow 300 that supports discontinuous communications in accordance with one or more aspects of the present disclosure. The process flow 300 may implement or be implemented to realize aspects of the wireless communications system 100 or the wireless communications system 200. For example, the process flow 300 may include a UE 115-b, which may be an example of the UE 115-a, as illustrated in FIG. 2, or other UEs 115, as illustrated in FIG. 1. Similarly, the process flow 300 may include a network entity 105-b, which may be an example of the network entity 105-a, as illustrated in FIG. 2, or other network entities, as illustrated in FIG. 1.

In the following description of the process flow 300, the operations between the UE 115-b and the network entity 105-b may occur in a different order than the example order shown and, in some examples, may be performed by one or more different devices other than those shown as examples. Some operations may also be omitted from the process flow 300, and other operations may be added to the process flow 300. Further, although some operations or signaling may be shown to occur at different times for discussion purposes, these operations may actually occur at the same time.

At 305, the network entity 105-b may transmit, and the UE 115-b may receive, control signaling indicating that the network entity 105-b supports UEs that assume threshold time gaps between communications. That is, the control signaling may indicate that the network entity 105-b supports gaps of a threshold time that is consistent with capabilities of the UE 115-b. The network entity 105-b may transmit the control signaling via SIB or SSB.

In cases in which the network entity 105-b transmits the control signaling via SSB, the network entity 105-b may include an indication that the network entity 105-b supports the threshold time gaps in general SSB (e.g., for both UEs that assume gaps and other UEs that do not implement gaps). In some examples, the network entity 105-b may include an explicit bit in MIB to indicate whether the network entity 105-b supports UEs that rely on the threshold time gaps between communications.

Additionally, or alternatively, the network entity 105-b may transmit SSBs specific to UEs that assume the threshold time gaps between communications (e.g., SSBs different from general SSBs for UEs that do not implement gaps). In some cases, one or more synchronization sequences (e.g., PSS, SSS) or DMRS sequences may indicate whether the network entity 105-b supports the threshold time gaps between communications. That is, the network entit 105-b may use an additional input (e.g., 1 bit) in a sequence generator or seed for the synchronization sequence or the DMRS sequence to adjust the sequence based on whether the network entity 105-b supports the threshold time gaps. In some implementations, the network entity 105-b may implement CRC masking to differentiate SSB specific to UEs that assume the threshold time gaps between communications from general SSB. For example, the use of a CRC mask on SSB may indicate that the network entity 105-b supports the threshold time gaps while unmasked SSB may indicate that the network entity 105-b does not support the threshold time gaps, or the use of a CRC mask on SSB may indicate that the network entity 105-b does not support the threshold time gaps while unmasked SSB may indicate that the network entity 105-b does support the threshold time gaps. In another example, the network entity 105-b may use separate CRC masks to distinguish cells that support the threshold time gaps from cells in which the threshold time gaps are unsupported (e.g., a first CRC mask indicates that the threshold time gaps are supported and a second CRC mask indicates that the threshold time gaps are unsupported).

At 310, the UE 115-b may, in some cases, transmit a first random access message (e.g., a random access message A (MsgA), a random access message 3 (Msg3)) to the network entity 105-b as part of an initial access procedure. That is, the UE 115-b may transmit the first random access message to request to connect to the network entity 105-b. The first random access message may include an indication of a type of time gap (e.g., time gaps between consecutive receptions from the network entity 105-b, consecutive transmissions to the network entity 105-b, or both) assumed by the UE 115-b. In some aspects, the UE 115-b may transmit the first random access message in accordance with the type of time gap. For example, the UE 115-b may assume gaps between consecutive transmission to the network entity 105-b, and the UE 115-b may accordingly implement gaps between repetitions or retransmissions of the first random access message. Similarly, the network entity 105-b may assume, or determine, based on capability information or the first random access message, that the UE 115-b does not support consecutive transmissions, and may ensure that downlink signaling (e.g., random access signaling, or other signaling) satisfies such gaps (e.g., repetitions or retransmission satisfy the gap).

In some examples, the UE 115-b may indicate that the UE 115-b assumes gaps, or the type of time gap, by selecting a RACH preamble from a set of RACH preambles configured for UEs that assume gaps between communications. The set of RACH preambles may be pre-defined (e.g., in one or more standards documents), indicated by the network entity 105-b (e.g., in SIB), specified as a modification to a generic RACH preamble, or defined by an input to a RACH preamble generator function. The UE 115-b may, in some implementations, indicate the type of time gap, or that the UE 115-b is an energy saving device, by selecting a RACH occasion from a set of RACH occasions configured for UEs that assume gaps between communications. For example, the network entity 105-b may signal (e.g., in SIB) a set of RACH occasions for UEs that assume gaps between communications, and the UE 115-b may transmit the first random access message at a RACH occasion corresponding to the type of UE, or to the type of time gap assumed by the UE 115-b. Additionally, or alternatively, the UE 115-b may indicate the type of time gap using a payload of the first random access message (e.g., which may be a MsgA or another message in a 2-step random access procedure or message 1 in a four-step random access procedure), or the UE 115-b may indicate the type of time gap using an early UE capability indication message.

At 315, the UE 115-b may, in some cases, monitor for a second random access message (e.g., a random access message 2 (Msg2), a random access message 4 (Msg4), a random access message B (MsgB), or any combination thereof) via one or more random access occasions in accordance with type of time gap assumed by the UE 115-b. That is, the UE 115-b may assume gaps between consecutive receptions from the network entity 105-b, and the UE 115-b may implement gaps (e.g., refrain from monitoring for a duration) between the one or more random access occasions, which may be indicated in a SIB, a MIB, an additional random access message, a configured periodicity for random access occasions, or any combination thereof. For example, the one or more random access occasions may be defined as a function of time (e.g., every 10th slot), or the one or more random access occasions may be indicated in SIB or MIB (e.g., as a time or slot offset and periodicity). Additionally, or alternatively, the one or more random access occasions may be based on a time or slot at which the UE 115-b transmits the first random access message. For example, the one or more random access occasions may be defined relative to the time or slot at which the UE 115-b transmits the first random access message (e.g., a first occasion of the one or more random access occasions may be two slots after the first random access message and subsequent random access occasions of the one or more random access occasions may be separated by gaps of two slots), or the one or more random access occasions may be configured (e.g., in SIB) relative to the time or slot at which the UE 115-b transmits the first random access message.

At 320, the network entity 105-b may, in some cases, transmit one or more random access messages to the UE (e.g., Msg2, MsgB, Msg4, etc.). For instance, in a two-step random access procedure, or a four-step random access procedure, the network entity 105-b may transmit a second random access message to the UE 115-b in response to the first random access message. The second random access message may allow the UE 115-b to connect to the network entity 105-b as part of the initial access procedure. In some aspects, the network entity 105-b may transmit the second random access message to the UE 115-b in accordance with the type of gap indicated in the first random access message. For example, the UE 115-b may indicate, in the first random access, that the UE 115-b assumes gaps between consecutive receptions from the network entity 105-b, and the network entity 105-b may accordingly implement gaps between reception of the first random access message and transmissions of the second random access message, or between repetitions or retransmission of the second random access message, or both.

At 325, the UE 115-b may, in some implementations, transmit a capability information message to the network entity 105-b. The capability information message may indicate a gap between communications at the UE 115-b. In some cases, the capability information message may indicate a type of gap at the UE 115-b (e.g., gaps between consecutive receptions from the network entity 105-b, gaps between consecutive transmissions to the network entity 105-b, or both), a duration of the gap (e.g., a quantity of slots or units of TTI, a quantity of OFDM symbols, a quantity of time), a duration of communications before the gap, or any combination thereof. In some implementations, the UE 115-b may transmit the capability information message based on connecting to the network entity 105-b through an initial access procedure (e.g., by exchanging the first random access message and second random access message at 310 and 320), and the capability information message may include additional information about the gap that may not be included in the first random access message. For example, the capability information message may include a quantity of consecutive communications (e.g., transmissions, receptions, or both) before the gap, a size (e.g., duration) of the gap, or a combination thereof.

At 330, the network entity 105-b may, in some aspects, transmit a control message to the UE 115-b. The control message may allocate resources for at least a first communication (e.g., a transmission, a reception) and a second communication, and the allocated resources may configure a gap (e.g., offset) between the first communication and the second communication in accordance with the gap indicated in the capability information message. For example, the capability information message may indicate a gap of two slots between consecutive receptions at the UE 115-b, and the control message may allocate first time resources for a first downlink communication that are offset from second time resources for a second downlink communication by two slots.

At 335, the network entity 105-b and the UE 115-b may perform wireless communications in accordance with the gap indicated in the capability information message. That is, individual communications between the network entity 105-b and the UE 115-b may be offset by the indicated gap. In some cases, the wireless communications may include the first communication and the second communication for which resources are allocated in the control message at 330.

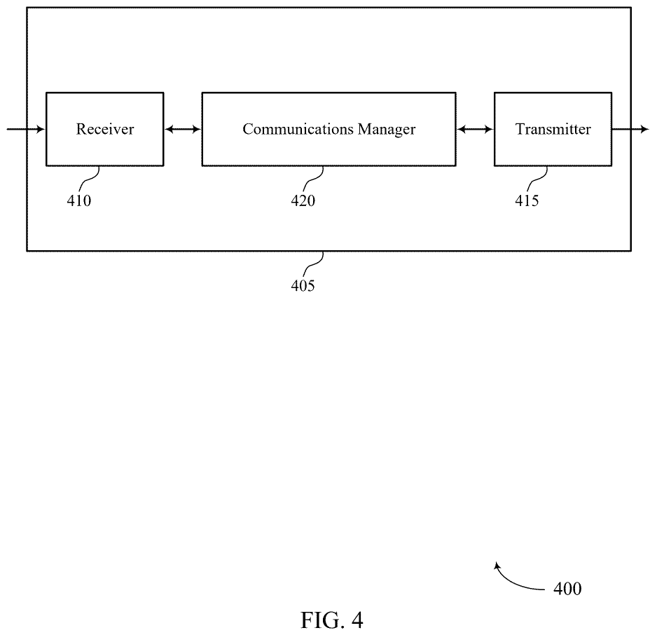

FIG. 4 shows a block diagram 400 of a device 405 that supports discontinuous communications in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to discontinuous communications). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to discontinuous communications). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of discontinuous communications as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication in accordance with examples as disclosed herein. For example, the communications manager 420 is capable of, configured to, or operable to support a means for receiving control signaling indicating that a network entity supports threshold time gaps between wireless communications scheduled at the UE. The communications manager 420 is capable of, configured to, or operable to support a means for performing the wireless communications with the network entity in accordance with at least the threshold time gaps between the wireless communications.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing, reduced power consumption, and reduced baseband implementation complexity.

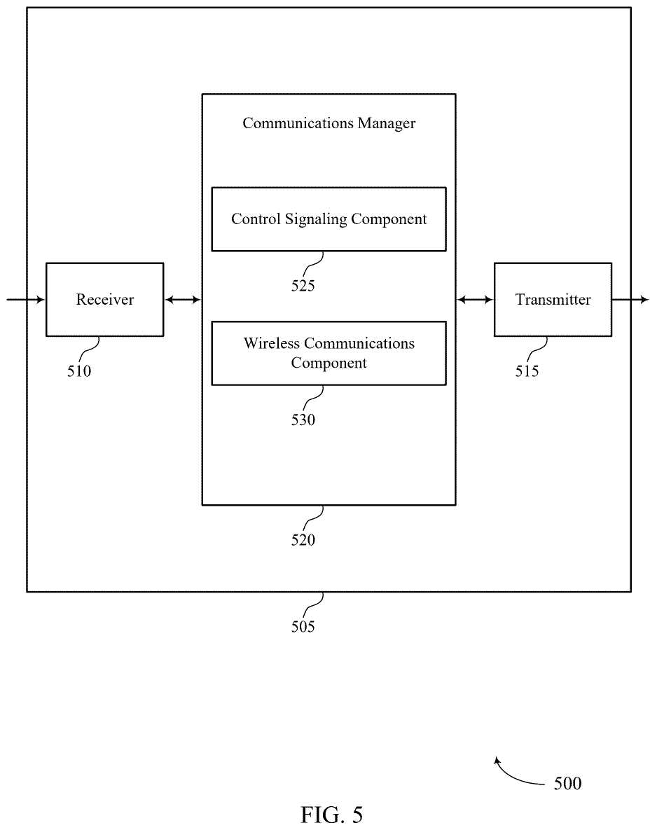

FIG. 5 shows a block diagram 500 of a device 505 that supports discontinuous communications in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to discontinuous communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to discontinuous communications). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of discontinuous communications as described herein. For example, the communications manager 520 may include a control signaling component 525, a wireless communications component 530, or both. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. The control signaling component 525 is capable of, configured to, or operable to support a means for receiving control signaling indicating that a network entity supports threshold time gaps between wireless communications scheduled at the UE. The wireless communications component 530 is capable of, configured to, or operable to support a means for performing the wireless communications with the network entity in accordance with at least the threshold time gaps between the wireless communications.

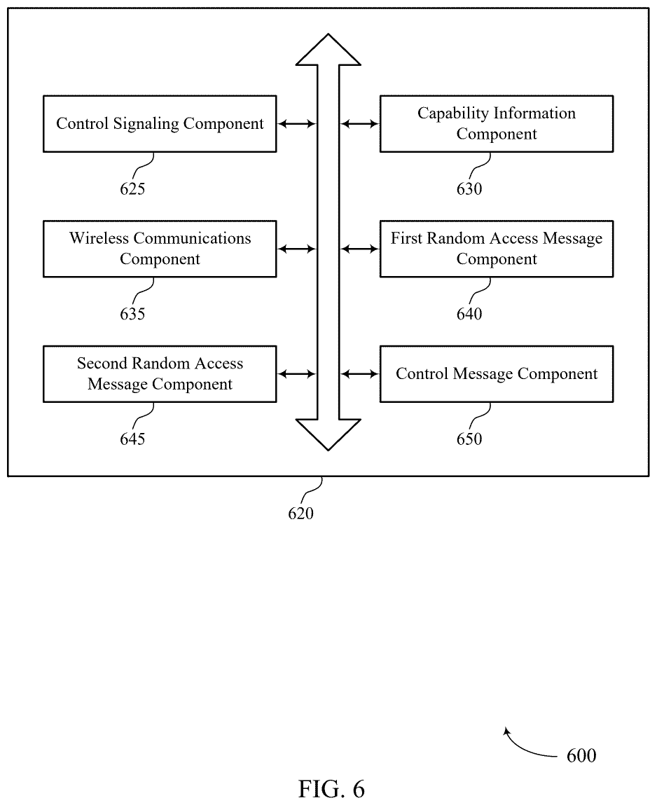

FIG. 6 shows a block diagram 600 of a communications manager 620 that supports discontinuous communications in accordance with one or more aspects of the present disclosure. The communications manager 620 may be an example of aspects of a communications manager 420, a communications manager 520, or both, as described herein. The communications manager 620, or various components thereof, may be an example of means for performing various aspects of discontinuous communications as described herein. For example, the communications manager 620 may include a control signaling component 625, a capability information component 630, a wireless communications component 635, a first random access message component 640, a second random access message component 645, a control message component 650, or any combination thereof. Each of these components, or components or subcomponents thereof (e.g., one or more processors, one or more memories), may communicate, directly or indirectly, with one another (e.g., via one or more buses).

The communications manager 620 may support wireless communication in accordance with examples as disclosed herein. The control signaling component 625 is capable of, configured to, or operable to support a means for receiving control signaling indicating that a network entity supports threshold time gaps between wireless communications scheduled at the UE. In some examples, the capability information component 630 is capable of, configured to, or operable to support a means for transmitting, in response to receiving the control signaling, a capability information message indicating a gap between communications at the UE, wherein performing the wireless communications is in accordance with the gap indicated in the capability information message. The wireless communications component 635 is capable of, configured to, or operable to support a means for performing the wireless communications with the network entity in accordance with at least the threshold time gaps between the wireless communications.

In some examples, the control signaling includes SIB or a MIB.

In some examples, the control signaling includes SSB.

In some examples, an SSB sequence is based on an input that indicates that the network entity supports the threshold time gaps.

In some examples, a DMRS sequence is based on an input that indicates that the network entity supports the threshold time gaps.

In some examples, a presence or an absence of at least one CRC mask indicates that the network entity supports the threshold time gaps.

In some examples, the first random access message component 640 is capable of, configured to, or operable to support a means for transmitting a first random access message as part of an initial access procedure based on receiving the control signaling, where the first random access message includes an indication that the gap is between consecutive receptions, consecutive transmissions, or both at the UE. In some examples, the second random access message component 645 is capable of, configured to, or operable to support a means for receiving a second random access message in response to the first random access message to connect to the network entity, where receiving the second random access message is in accordance with the indication, and where transmitting the capability information message is based on connecting to the network entity.

In some examples, the indication includes at least one of a RACH preamble, a RACH occasion, a random access message payload, and an early UE capability indication message.

In some examples, the second random access message component 645 is capable of, configured to, or operable to support a means for monitoring for the second random access message via one or more random access occasions that occur at least an amount of time that satisfies the gap after transmitting the first random access message, where the one or more random access occasions are indicated via a SIB, a MIB, an additional random access message, a periodicity for random access occasions, or any combination thereof.

In some examples, the capability information message includes at least one of a duration of the gap and a quantity of consecutive communications before the gap.

In some examples, the capability information message includes an indication that the gap is between consecutive receptions, consecutive transmissions, or both at the UE.

In some examples, the capability information message includes at least one of an indication of a duration of the gap and a duration of communications before the gap.

In some examples, the control message component 650 is capable of, configured to, or operable to support a means for receiving a control message allocating resources for a first communication and a second communication, where the second communication is offset from the first communication by at least the gap indicated in the capability information message, and where performing the wireless communications is based on receiving the control message.

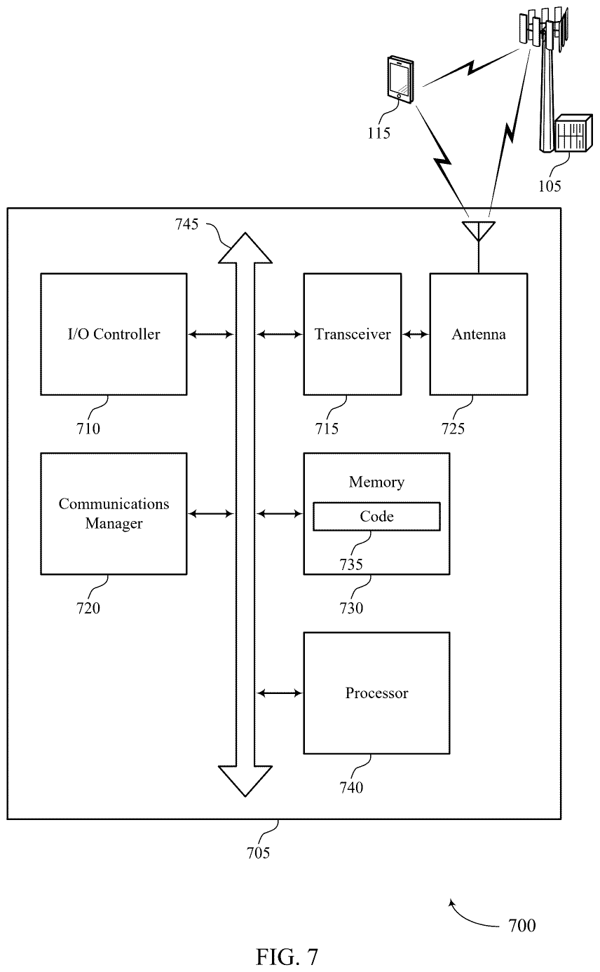

FIG. 7 shows a diagram of a system 700 including a device 705 that supports discontinuous communications in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting discontinuous communications). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communication in accordance with examples as disclosed herein. For example, the communications manager 720 is capable of, configured to, or operable to support a means for receiving control signaling indicating that a network entity supports threshold time gaps between wireless communications scheduled at the UE. The communications manager 720 is capable of, configured to, or operable to support a means for performing the wireless communications with the network entity in accordance with at least the threshold time gaps between the wireless communications.

By including or configuring the communications manager 720 in accordance with examples as described herein, the device 705 may support techniques for improved communication reliability, reduced power consumption, reduced overhead, more efficient utilization of communication resources, longer battery life, and improved utilization of processing capability.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of discontinuous communications as described herein, or the at least one processor 740 and the at least one memory 730 may be otherwise configured to, individually or collectively, perform or support such operations.

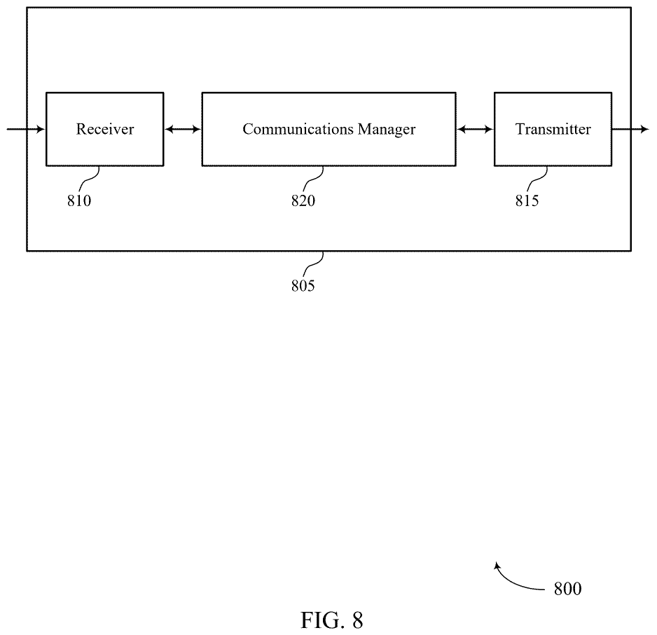

FIG. 8 shows a block diagram 800 of a device 805 that supports discontinuous communications in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of discontinuous communications as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. For example, the communications manager 820 is capable of, configured to, or operable to support a means for transmitting control signaling indicating that the network entity supports threshold time gaps between wireless communications scheduled at a UE. The communications manager 820 is capable of, configured to, or operable to support a means for performing the wireless communications with the UE in accordance with at least tthe threshold time gaps between the wireless communications.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, more efficient utilization of communication resources.

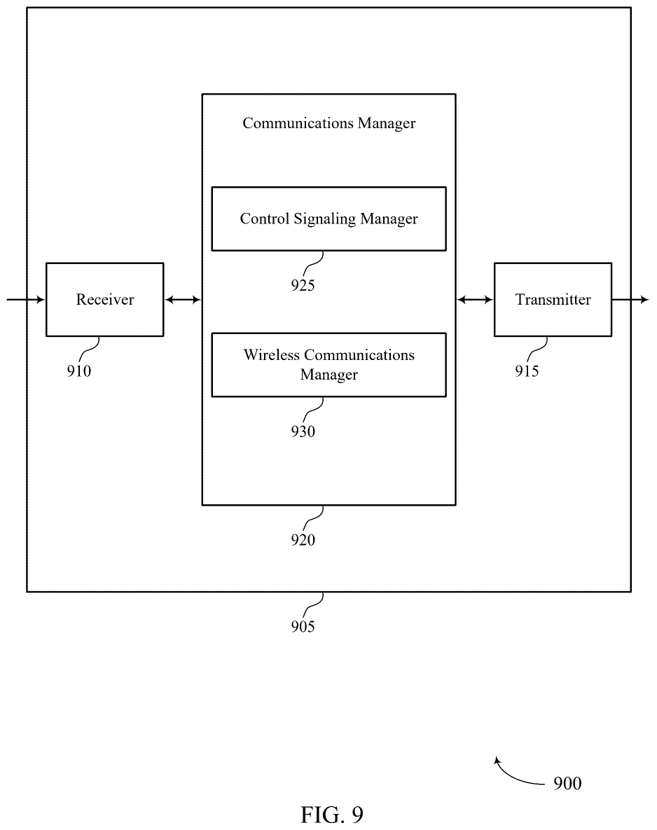

FIG. 9 shows a block diagram 900 of a device 905 that supports discontinuous communications in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of discontinuous communications as described herein. For example, the communications manager 920 may include a control signaling manager 925, a wireless communications manager 930, or both. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. The control signaling manager 925 is capable of, configured to, or operable to support a means for transmitting control signaling indicating that the network entity supports threshold time gaps between wireless communications scheduled at a UE. The wireless communications manager 930 is capable of, configured to, or operable to support a means for performing the wireless communications with the UE in accordance with at least the threshold time gaps between the wireless communications.

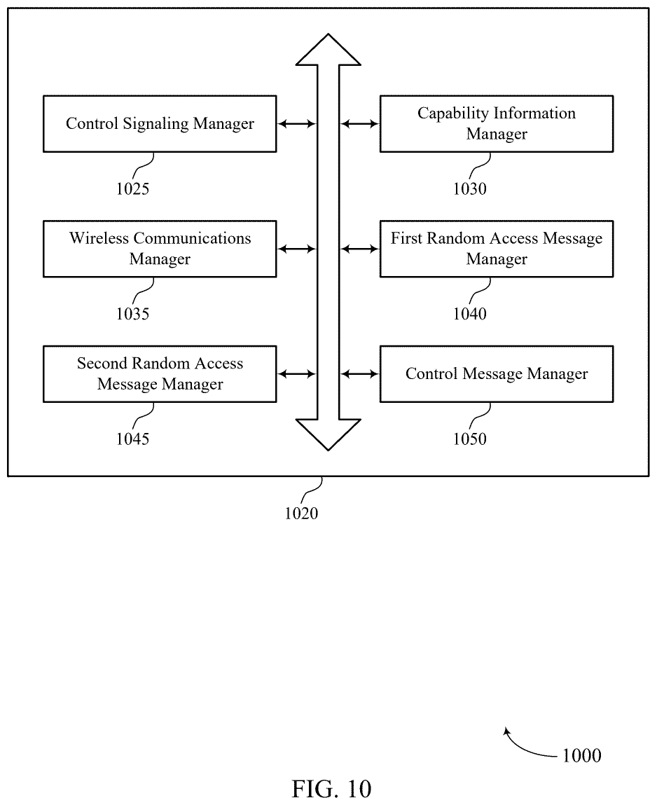

FIG. 10 shows a block diagram 1000 of a communications manager 1020 that supports discontinuous communications in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of discontinuous communications as described herein. For example, the communications manager 1020 may include a control signaling manager 1025, a capability information manager 1030, a wireless communications manager 1035, a first random access message manager 1040, a second random access message manager 1045, a control message manager 1050, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication in accordance with examples as disclosed herein. The control signaling manager 1025 is capable of, configured to, or operable to support a means for transmitting control signaling indicating that the network entity supports threshold time gaps between wireless communications scheduled at a UE. In some examples, the capability information manager 1030 is capable of, configured to, or operable to support a means for receiving, in response to transmitting the control signaling, a capability information message indicating a gap between communications at the UE, wherein performing the wireless communications is in accordance with the gap indicated in the capability information message. The wireless communications manager 1035 is capable of, configured to, or operable to support a means for performing the wireless communications with the UE in accordance with at least the threshold time gaps between the wireless communications.

In some examples, the control signaling includes SIB or a MIB.

In some examples, the control signaling includes SSB.

In some examples, an SSB sequence is based on an input that indicates that the network entity supports the threshold time gaps.

In some examples, a DMRS sequence is based on an input that indicates that the network entity supports the threshold time gaps.

In some examples, a presence or an absence of at least one CRC mask indicates that the network entity supports the threshold time gaps.

In some examples, the first random access message manager 1040 is capable of, configured to, or operable to support a means for receiving a first random access message as part of an initial access procedure based on transmitting the control signaling, where the first random access message includes an indication that the gap is between consecutive receptions, consecutive transmissions, or both at the UE. In some examples, the second random access message manager 1045 is capable of, configured to, or operable to support a means for transmitting a second random access message in response to the first random access message indicating to the UE to connect to the network entity, where transmitting the second random access message is in accordance with the indication, and where receiving the capability information message is based on the UE connecting to the network entity.

In some examples, the indication includes at least one of a RACH preamble, a RACH occasion, a random access message payload, and an early UE capability indication message.

In some examples, the capability information message includes at least one of a duration of the gap and a quantity of consecutive communications before the gap.

In some examples, the capability information message includes an indication that the gap is between consecutive receptions, consecutive transmissions, or both at the UE.

In some examples, the capability information message includes at least one of an indication of a duration of the gap and a duration of communications before the gap.

In some examples, the control message manager 1050 is capable of, configured to, or operable to support a means for transmitting a control message allocating resources for a first communication and a second communication, where the second communication is offset from the first communication by at least the gap indicated in the capability information message, and where performing the wireless communications is based on transmitting the control message.

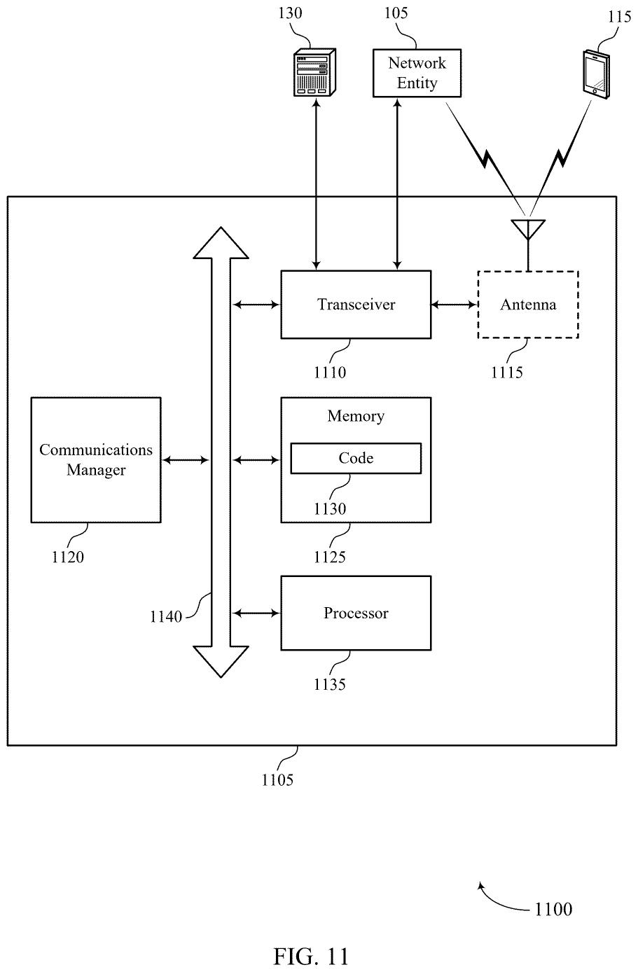

FIG. 11 shows a diagram of a system 1100 including a device 1105 that supports discontinuous communications in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting discontinuous communications). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communication in accordance with examples as disclosed herein. For example, the communications manager 1120 is capable of, configured to, or operable to support a means for transmitting control signaling indicating that the network entity supports threshold time gaps between wireless communications scheduled at a UE. The communications manager 1120 is capable of, configured to, or operable to support a means for performing the wireless communications with the UE in accordance with at least the threshold time gaps between the wireless communications.

By including or configuring the communications manager 1120 in accordance with examples as described herein, the device 1105 may support techniques for reduced power consumption, more efficient utilization of communication resources, longer battery life, and improved utilization of processing capability.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of discontinuous communications as described herein, or the at least one processor 1135 and the at least one memory 1125 may be otherwise configured to, individually or collectively, perform or support such operations.

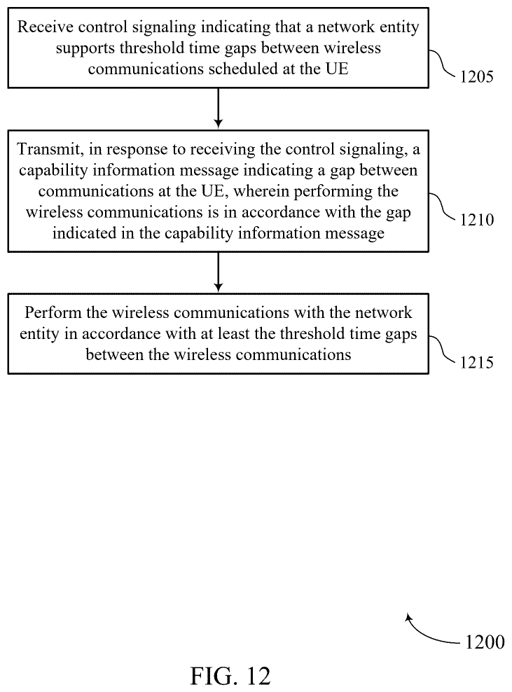

FIG. 12 shows a flowchart illustrating a method 1200 that supports discontinuous communications in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving control signaling indicating that a network entity supports threshold time gaps between wireless communications scheduled at the UE. The operations of 1205 may be performed in accordance with examples as disclosed herein. In some examples, aspects of the operations of 1205 may be performed by a control signaling component 625 as described with reference to FIG. 6.

At 1210, the method may include transmitting, in response to receiving the control signaling, a capability information message indicating a gap between communications at the UE, wherein performing the wireless communications is in accordance with the gap indicated in the capability information message. The operations of 1210 may be performed in accordance with examples as disclosed herein. In some examples, aspects of the operations of 1210 may be performed by a capability information component 630 as described with reference to FIG. 6.

At 1215, the method may include performing the wireless communications with the network entity in accordance with at least the threshold time gaps between the wireless communications. The operations of 1215 may be performed in accordance with examples as disclosed herein. In some examples, aspects of the operations of 1215 may be performed by a wireless communications component 635 as described with reference to FIG. 6.

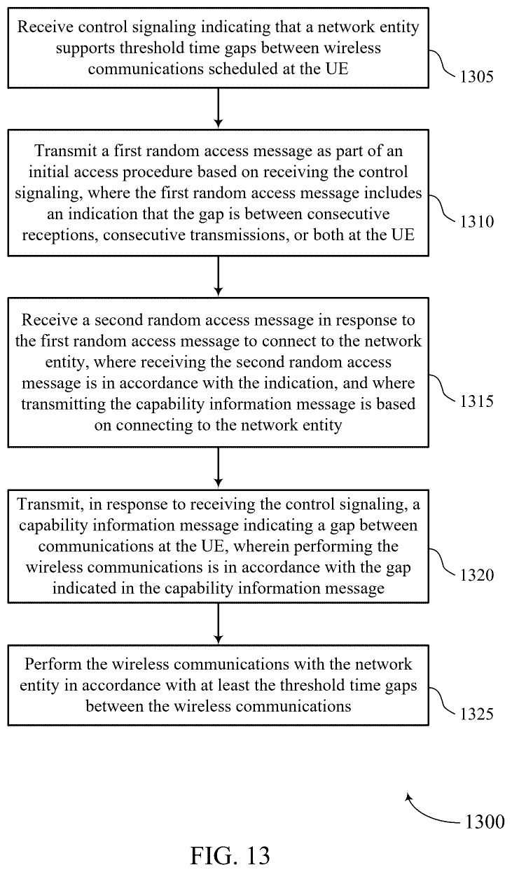

FIG. 13 shows a flowchart illustrating a method 1300 that supports discontinuous communications in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving control signaling indicating that a network entity supports threshold time gaps between wireless communications scheduled at the UE. The operations of 1305 may be performed in accordance with examples as disclosed herein. In some examples, aspects of the operations of 1305 may be performed by a control signaling component 625 as described with reference to FIG. 6.

At 1310, the method may include transmitting a first random access message as part of an initial access procedure based on receiving the control signaling, where the first random access message includes an indication that the gap is between consecutive receptions, consecutive transmissions, or both at the UE. The operations of 1310 may be performed in accordance with examples as disclosed herein. In some examples, aspects of the operations of 1310 may be performed by a first random access message component 640 as described with reference to FIG. 6.

At 1315, the method may include receiving a second random access message in response to the first random access message to connect to the network entity, where receiving the second random access message is in accordance with the indication, and where transmitting the capability information message is based on connecting to the network entity. The operations of 1315 may be performed in accordance with examples as disclosed herein. In some examples, aspects of the operations of 1315 may be performed by a second random access message component 645 as described with reference to FIG. 6.

At 1320, the method may include transmitting, in response to receiving the control signaling, a capability information message indicating a gap between communications at the UE, wherein performing the wireless communications is in accordance with the gap indicated in the capability information message. The operations of 1320 may be performed in accordance with examples as disclosed herein. In some examples, aspects of the operations of 1320 may be performed by a capability information component 630 as described with reference to FIG. 6.

At 1325, the method may include performing the wireless communications with the network entity in accordance with at least the threshold time gaps between the wireless communications. The operations of 1325 may be performed in accordance with examples as disclosed herein. In some examples, aspects of the operations of 1325 may be performed by a wireless communications component 635 as described with reference to FIG. 6.

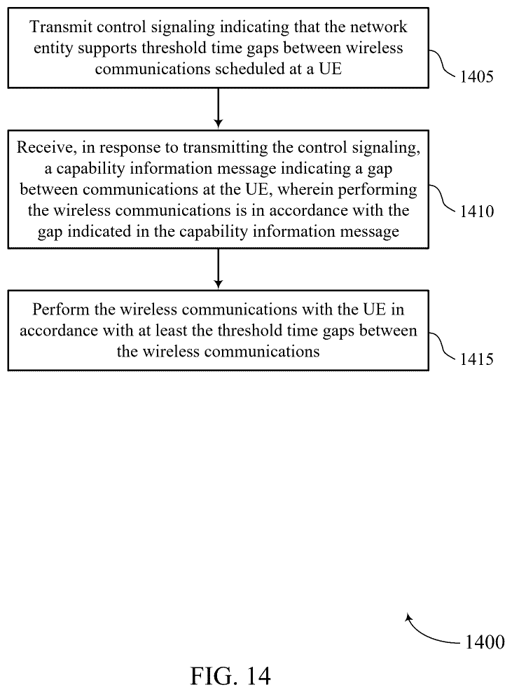

FIG. 14 shows a flowchart illustrating a method 1400 that supports discontinuous communications in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include transmitting control signaling indicating that the network entity supports threshold time gaps between wireless communications scheduled at a UE. The operations of 1405 may be performed in accordance with examples as disclosed herein. In some examples, aspects of the operations of 1405 may be performed by a control signaling manager 1025 as described with reference to FIG. 10.

At 1410, the method may include receiving, in response to transmitting the control signaling, a capability information message indicating a gap between communications at the UE, wherein performing the wireless communications is in accordance with the gap indicated in the capability information message. The operations of 1410 may be performed in accordance with examples as disclosed herein. In some examples, aspects of the operations of 1410 may be performed by a capability information manager 1030 as described with reference to FIG. 10.

At 1415, the method may include performing the wireless communications with the UE in accordance with at least the threshold time gaps between the wireless communications. The operations of 1415 may be performed in accordance with examples as disclosed herein. In some examples, aspects of the operations of 1415 may be performed by a wireless communications manager 1035 as described with reference to FIG. 10.

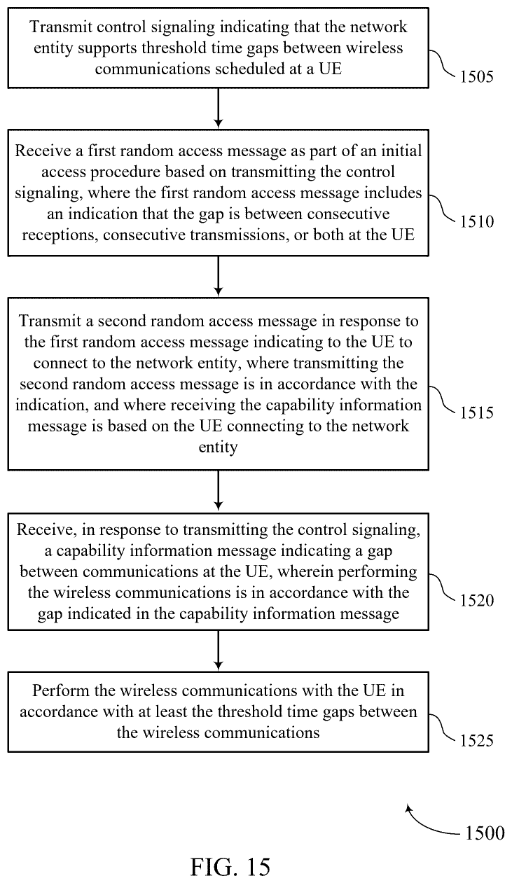

FIG. 15 shows a flowchart illustrating a method 1500 that supports discontinuous communications in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include transmitting control signaling indicating that the network entity supports threshold time gaps between wireless communications scheduled at a UE. The operations of 1505 may be performed in accordance with examples as disclosed herein. In some examples, aspects of the operations of 1505 may be performed by a control signaling manager 1025 as described with reference to FIG. 10.

At 1510, the method may include receiving a first random access message as part of an initial access procedure based on transmitting the control signaling, where the first random access message includes an indication that the gap is between consecutive receptions, consecutive transmissions, or both at the UE. The operations of 1510 may be performed in accordance with examples as disclosed herein. In some examples, aspects of the operations of 1510 may be performed by a first random access message manager 1040 as described with reference to FIG. 10.

At 1515, the method may include transmitting a second random access message in response to the first random access message indicating to the UE to connect to the network entity, where transmitting the second random access message is in accordance with the indication, and where receiving the capability information message is based on the UE connecting to the network entity. The operations of 1515 may be performed in accordance with examples as disclosed herein. In some examples, aspects of the operations of 1515 may be performed by a second random access message manager 1045 as described with reference to FIG. 10.

At 1520, the method may include receiving, in response to transmitting the control signaling, a capability information message indicating a gap between communications at the UE, wherein performing the wireless communications is in accordance with the gap indicated in the capability information message. The operations of 1520 may be performed in accordance with examples as disclosed herein. In some examples, aspects of the operations of 1520 may be performed by a capability information manager 1030 as described with reference to FIG. 10.

At 1525, the method may include performing the wireless communications with the UE in accordance with at least the threshold time gaps between communications. The operations of 1525 may be performed in accordance with examples as disclosed herein. In some examples, aspects of the operations of 1525 may be performed by a wireless communications manager 1035 as described with reference to FIG. 10.

The following provides an overview of aspects of the present disclosure:

Aspect 1: A method for wireless communication by a UE, comprising: receiving control signaling indicating that a network entity supports threshold time gaps between wireless communications scheduled at the UE; and performing the wireless communications with the network entity in accordance with at least the threshold time gaps between the wireless communications.

Aspect 2: The method of aspect 1, wherein the control signaling comprises SIB or a MIB.

Aspect 3: The method of any of aspects 1 through 2, wherein the control signaling comprises an SSB.

Aspect 4: The method of aspect 3, wherein an SSB sequence is based at least in part on an input that indicates that the network entity supports the threshold time gaps.

Aspect 5: The method of any of aspects 3 through 4, wherein a DMRS sequence is based at least in part on an input that indicates that the network entity supports the threshold time gaps.

Aspect 6: The method of any of aspects 3 through 5, wherein a presence or an absence of at least one CRC mask indicates that the network entity supports the threshold time gaps.

Aspect 7: The method of any of aspects 1 through 6, further comprising: transmitting, in response to receiving the control signaling, a capability information message indicating a gap between communications at the UE, wherein performing the wireless communications is in accordance with the gap indicated in the capability information message.

Aspect 8: The method of aspect 7, wherein the capability information message comprises an indication that the gap is between consecutive receptions, consecutive transmissions, or both at the UE.

Aspect 9: The method of any of aspects 7 through 8, wherein the capability information message comprises at least one of an indication of a duration of the gap and a duration of communications before the gap.

Aspect 10: The method of any of aspects 7 through 9, further comprising: transmitting a first random access message as part of an initial access procedure based at least in part on receiving the control signaling, wherein the first random access message comprises an indication that the gap is between consecutive receptions, consecutive transmissions, or both at the UE; and receiving a second random access message in response to the first random access message to connect to the network entity, wherein receiving the second random access message is in accordance with the indication, and wherein transmitting the capability information message is based at least in part on connecting to the network entity.

Aspect 11: The method of aspect 10, wherein the indication comprises at least one of a RACH preamble, a RACH occasion, a random access message payload, and an early UE capability indication message.

Aspect 12: The method of any of aspects 10 through 11, further comprising: monitoring for the second random access message via one or more random access occasions that occur at least an amount of time that satisfies the gap after transmitting the first random access message, wherein the one or more random access occasions are indicated via a SIB, a MIB, an additional random access message, a periodicity for random access occasions, or any combination thereof.

Aspect 13: The method of any of aspects 10 through 12, wherein the capability information message comprises at least one of a duration of the gap and a quantity of consecutive communications before the gap.

Aspect 14: The method of any of aspects 7 through 13, further comprising: receiving a control message allocating resources for a first communication and a second communication, wherein the second communication is offset from the first communication by at least the gap indicated in the capability information message, and wherein performing the wireless communications is based at least in part on receiving the control message.

Aspect 15: A method for wireless communication by a network entity, comprising: transmitting control signaling indicating that the network entity supports threshold time gaps between wireless communications scheduled at a UE; and performing the wireless communications with the UE in accordance with at least the threshold time gaps between the wireless communications.

Aspect 16: The method of aspect 15, wherein the control signaling comprises SIB or a MIB.

Aspect 17: The method of any of aspects 15 through 16, wherein the control signaling comprises a SSB.

Aspect 18: The method of aspect 17, wherein a SSB sequence is based at least in part on an input that indicates that the network entity supports the threshold time gaps.

Aspect 19: The method of any of aspects 17 through 18, wherein a DMRS sequence is based at least in part on an input that indicates that the network entity supports the threshold time gaps.

Aspect 20: The method of any of aspects 17 through 19, wherein a presence or an absence of at least one CRC mask indicates that the network entity supports the threshold time gaps.

Aspect 21: The method of any of aspects 15 through 20, further comprising: receiving, in response to transmitting the control signaling, a capability information message indicating a gap between communications at the UE, wherein performing the wireless communications is in accordance with the gap indicated in the capability information message.

Aspect 22: The method of aspect 21, wherein the capability information message comprises an indication that the gap is between consecutive receptions, consecutive transmissions, or both at the UE.

Aspect 23: The method of any of aspects 21 through 22, wherein the capability information message comprises at least one of an indication of a duration of the gap and a duration of communications before the gap.

Aspect 24: The method of any of aspects 21 through 23, further comprising: receiving a first random access message as part of an initial access procedure based at least in part on transmitting the control signaling, wherein the first random access message comprises an indication that the gap is between consecutive receptions, consecutive transmissions, or both at the UE; and transmitting a second random access message in response to the first random access message indicating to the UE to connect to the network entity, wherein transmitting the second random access message is in accordance with the indication, and wherein receiving the capability information message is based at least in part on the UE connecting to the network entity.

Aspect 25: The method of aspect 24, wherein the indication comprises at least one of a RACH preamble, a RACH occasion, a random access message payload, and an early UE capability indication message.

Aspect 26: The method of any of aspects 24 through 25, wherein the capability information message comprises at least one of a duration of the gap and a quantity of consecutive communications before the gap.

Aspect 27: The method of any of aspects 21 through 26, further comprising: transmitting a control message allocating resources for a first communication and a second communication, wherein the second communication is offset from the first communication by at least the gap indicated in the capability information message, and wherein performing the wireless communications is based at least in part on transmitting the control message.

Aspect 28: A UE for wireless communication, comprising one or more memories storing processor-executable code, and one or more processors coupled with the one or more memories and individually or collectively operable to execute the code to cause the UE to perform a method of any of aspects 1 through 14.

Aspect 29: A UE for wireless communication, comprising at least one means for performing a method of any of aspects 1 through 14.

Aspect 30: A non-transitory computer-readable medium storing code for wireless communication, the code comprising instructions executable by one or more processors to perform a method of any of aspects 1 through 14.

Aspect 31: A network entity for wireless communication, comprising one or more memories storing processor-executable code, and one or more processors coupled with the one or more memories and individually or collectively operable to execute the code to cause the network entity to perform a method of any of aspects 15 through 27.

Aspect 32: A network entity for wireless communication, comprising at least one means for performing a method of any of aspects 15 through 27.

Aspect 33: A non-transitory computer-readable medium storing code for wireless communication, the code comprising instructions executable by one or more processors to perform a method of any of aspects 15 through 27.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
one or more processors; and
instructions stored in one or more memories and executable by the one or more processors, individually or collectively, to cause the apparatus to:
receive control signaling indicating that a network entity supports threshold time gaps between wireless communications scheduled at the UE; and
perform the wireless communications with the network entity in accordance with at least the threshold time gaps between the wireless communications.

2. The apparatus of claim 1, wherein the control signaling comprises system information block or a master information block.

3. The apparatus of claim 1, wherein the control signaling comprises a synchronization signal block.

4. The apparatus of claim 3, wherein a synchronization signal block sequence is based at least in part on an input that indicates that the network entity supports the threshold time gaps.

5. The apparatus of claim 3, wherein a demodulation reference signal sequence is based at least in part on an input that indicates that the network entity supports the threshold time gaps.

6. The apparatus of claim 3, wherein a presence or an absence of at least one cyclic redundancy check mask indicates that the network entity supports the threshold time gaps.

7. The apparatus of claim 1, wherein the instructions are further executable by the one or more processors, individually or collectively, to cause the apparatus to:
transmit, in response to receiving the control signaling, a capability information message indicating a gap between communications at the UE, wherein performing the wireless communications is in accordance with the gap indicated in the capability information message.

8. The apparatus of claim 7, wherein the capability information message comprises an indication that the gap is between consecutive receptions, consecutive transmissions, or both at the UE.

9. The apparatus of claim 7, wherein the capability information message comprises at least one of an indication of a duration of the gap and a duration of communications before the gap.

10. The apparatus of claim 7, wherein the instructions are further executable by the one or more processors, individually or collectively, to cause the apparatus to:
transmit a first random access message as part of an initial access procedure based at least in part on receiving the control signaling, wherein the first random access message comprises an indication that the gap is between consecutive receptions, consecutive transmissions, or both at the UE; and
receive a second random access message in response to the first random access message to connect to the network entity, wherein receiving the second random access message is in accordance with the indication, and wherein transmitting the capability information message is based at least in part on connecting to the network entity.

11. The apparatus of claim 10, wherein the indication comprises at least one of a random access channel preamble, a random access channel occasion, a random access message payload, and an early UE capability indication message.

12. The apparatus of claim 10, wherein the instructions are further executable by the one or more processors, individually or collectively, to cause the apparatus to:
monitor for the second random access message via one or more random access occasions that occur at least an amount of time that satisfies the gap after transmitting the first random access message, wherein the one or more random access occasions are indicated via a system information block, a master information block, an additional random access message, a periodicity for random access occasions, or any combination thereof.

13. The apparatus of claim 10, wherein the capability information message comprises at least one of a duration of the gap and a quantity of consecutive communications before the gap.

14. The apparatus of claim 7, wherein the instructions are further executable by the one or more processors, individually or collectively, to cause the apparatus to:
receive a control message allocating resources for a first communication and a second communication, wherein the second communication is offset from the first communication by at least the gap indicated in the capability information message, and wherein performing the wireless communications is based at least in part on receiving the control message.

15. An apparatus for wireless communications at a network entity, comprising:
one or more processors; and
instructions stored in one or more memories and executable by the one or more processors, individually or collectively, to cause the apparatus to:
transmit control signaling indicating that the network entity supports threshold time gaps between wireless communications scheduled at a UE; and
perform the wireless communications with the UE in accordance with at least the threshold time gaps between the wireless communications.

16. The apparatus of claim 15, wherein the control signaling comprises system information block or a master information block.

17. The apparatus of claim 15, wherein the control signaling comprises a synchronization signal block.

18. The apparatus of claim 17, wherein a synchronization signal block sequence is based at least in part on an input that indicates that the network entity supports the threshold time gaps.

19. The apparatus of claim 17, wherein a demodulation reference signal sequence is based at least in part on an input that indicates that the network entity supports the threshold time gaps.

20. The apparatus of claim 17, wherein a presence or an absence of at least one cyclic redundancy check mask indicates that the network entity supports the threshold time gaps.

21. The apparatus of claim 15, wherein the instructions are further executable by the one or more processors, individually or collectively, to cause the apparatus to:
receive, in response to transmitting the control signaling, a capability information message indicating a gap between communications at the UE, wherein performing the wireless communications is in accordance with the gap indicated in the capability information message.

22. The apparatus of claim 21, wherein the capability information message comprises an indication that the gap is between consecutive receptions, consecutive transmissions, or both at the UE.

23. The apparatus of claim 21, wherein the capability information message comprises at least one of an indication of a duration of the gap and a duration of communications before the gap.

24. The apparatus of claim 21, wherein the instructions are further executable by the one or more processors, individually or collectively, to cause the apparatus to:
receive a first random access message as part of an initial access procedure based at least in part on transmitting the control signaling, wherein the first random access message comprises an indication that the gap is between consecutive receptions, consecutive transmissions, or both at the UE; and
transmit a second random access message in response to the first random access message indicating to the UE to connect to the network entity, wherein transmitting the second random access message is in accordance with the indication, and wherein receiving the capability information message is based at least in part on the UE connecting to the network entity.

25. The apparatus of claim 24, wherein the indication comprises at least one of a random access channel preamble, a random access channel occasion, a random access message payload, and an early UE capability indication message.

26. The apparatus of claim 24, wherein the capability information message comprises at least one of a duration of the gap and a quantity of consecutive communications before the gap.

27. The apparatus of claim 21, wherein the instructions are further executable by the one or more processors, individually or collectively, to cause the apparatus to:
transmit a control message allocating resources for a first communication and a second communication, wherein the second communication is offset from the first communication by at least the gap indicated in the capability information message, and wherein performing the wireless communications is based at least in part on transmitting the control message.

28. A method for wireless communication by a user equipment (UE), comprising:
receiving control signaling indicating that a network entity supports threshold time gaps between wireless communications scheduled at the UE; and
performing the wireless communications with the network entity in accordance with at least the threshold time gaps between the wireless communications.

29. The method of claim 28, further comprising:
transmitting, in response to receiving the control signaling, a capability information message indicating a gap between communications at the UE, wherein performing the wireless communications is in accordance with the gap indicated in the capability information message.

30. A method for wireless communication by a network entity, comprising:
transmitting control signaling indicating that the network entity supports threshold time gaps between wireless communications scheduled at a UE; and
performing the wireless communications with the UE in accordance with at least the threshold time gaps between the wireless communications.
